(19) United States
(12) Patent Application Publication
(10) Pub. No.: US 2006/0074647 A1
(43) Pub. Date: Apr. 6, 2006

(54) Device for recording air-conditioning variables

(75) Inventor: Yves Luthi, Muri (CH)

Correspondence Address: Maginot, Moore & Beck;Bank One Tower, Suite 3000, 111 Monument Circle, Indianapolis, IN, 46204, US

(73) Assignee: Siemens Schwiez AG, Zurich (CH)

(21) Appl. No.: 11/219,245

(22) Filed: Sep. 2, 2005

Related U.S. Application Data
(60) Provisional application No. 60/607,935, filed on Sep. 8, 2004.

(30) Foreign Application Priority Data
Sep. 3, 2004 (EP) 040104258

(51) Int. Cl. G10L 21/02

(52) U.S. Cl. 704/226

(57) ABSTRACT

A device for recording air-conditioning variables in a room (R) of a building comprises a basic device (1) and an auxiliary device (2), arranged at a distance (L) from said basic device. Sound waves (A1) emitted by the basic device are detected by the auxiliary device (2). The point in time of the arrival of the sound waves (A1) is transmitted from the auxiliary device (2) to the basic device (1) over a signaling channel (S). In an advantageous variant of the device, the auxiliary device (2) also has a sound transmitter (25). In the basic device (1), sound waves (A2) that are reflected or emitted by the auxiliary device (2) can be detected. An air movement (W) in the room (R) of a building can be recorded from a difference between direction-dependent transit times of the sound waves (A1 and A2). With the aid of the transit time of the sound waves (A1 or A2), an average temperature (T) in the room of a building can also be measured.

This application claims the benefit of U.S. Provisional Patent Application Ser. No. 60,607,935 filed Sep. 8, 2004, and European Patent Application No. IP04104258, filed Sep. 3, 2004

### FIELD OF THE INVENTION

The invention relates to a device and a method according to the precharacterizing clauses of claims 1 and 6.

### BACKGROUND

Such devices and methods are advantageously used in buildings for recording air-conditioning variables. The proposed device is a room comfort sensor, with which it is possible to record a humidity and, with the aid of sound waves, an average temperature and an air movement in the room. The air-conditioning variables that are recorded form the basis for assessing the situation in a room with respect to comfortable conditions. The room comfort sensor can be used for example in heating, ventilation and air-conditioning technology for recording actual values for regulating the air conditions in a room.

EP-A-1 203 936 proposes a device for recording an average room temperature with the aid of sound waves. The sound waves generated by a transceiver travel over a path lying between the transmitter and an obstacle, some of the sound waves being reflected at the obstacle and received again by the transceiver. In an iteration process, the path traveled twice by the sound waves and the average room temperature prevailing in the area of the path are determined. The known device has a humidity sensor and preferably also a tempterature sensor, the measured values of which are required for carrying out the iteration process. In this respect, reference is made to EP-A-1 203 936, the content of which is hereby incorporated in this application.

With growing demands for comfortable conditions in rooms of buildings, there is a need for measuring methods and sensor units with which measured values relevant for comfortable conditions can be recorded.

To describe or determine the thermal comfort of a room, or the thermal conditions that a user of the room would be likely to find comfortable, the literature proposes various methods, in which for example air temperature, air humidity, air speed and degree of turbulence are taken into account. A thermal comfort measuring instrument devised by Fanger/Madsen (Recknagel, Sprenger, Schramek: Taschenbuch fur Heizung und Klimatechnik [pocketbook for heating and air-conditioning technology], Munich 1999, page 72) may be mentioned here as representative of the means used for measuring comfortable conditions.

DE-A-198 22 102 proposes a comfort sensor which has a temperature sensor which is enclosed by a hollow body with good heat conduction.

DE-A-100 50 235 proposes an air-conditioning sensor which is cooled below the dew point and on the surface of which moisture from the ambient air precipitates. The sensor is heated up at time intervals to human body temperature.

DE-A-198 34 250 and DE-A-197 02 622 disclose air-conditioning thermoanemometers for determining an air flow in a room.

In DE-A-198 55 056, a ventilation system with a number of sensors for recording temperature, humidity, CO2, air quality and air flow is disclosed.

Known devices for recording the air conditions in a room generally involve considerable expenditure with respect to production or adjustment; not all the variables that essentially determine the air conditions in a room can be recorded by the device; or the device is not restricted to the variables necessary for determining the air conditions in a room. Known devices also record an air-conditioning variable very locally at one point of a room of a building at which the sensor concerned is positioned.

### SUMMARY

The invention is based on the object of providing a low-cost comfort sensor unit for recording those measured variables that essentially determine the comfortable conditions of a room of a building.

The object is achieved by embodiments of the invention.

It has been found that conditions felt to be comfortable by users of a room of a building depend in particular on air temperature, air humidity and air movement.

According to the invention, air movement in the room of a building is determined with the aid of sound waves, an acoustic path being used, with the aid of which, and with a determined humidity of the air taken into account, an average air temperature of the room of a building is also determined. With a favorable alignment of the acoustic path in the room of a building, meaningful average values can be recorded for air temperature and air draft.

The fundamentals of sound wave propagation are generally known, for example from V. Sutilov, Physik des Ultraschalls [ultrasonic physics], Springerverlag, 1984. For air at a temperature of 0° C., the speed of sound c₀ is 332 ms⁻¹. The speed of sound in air is dependent on the humidity and the temperature.

Unless defined any more specifically, the expressions sound or sound wave generally mean in this document sound waves in the frequency ranges of audible sound (16 Hz≦f≦16 kHz) or ultrasound (f>16 kHz).

It goes without saying that the frequency of the sound waves used is chosen in the range of ultrasound if the room of a building is a room used for residential or working purposes.

The frequency of the sound waves which can be used in practice is limited in the downward direction to approximately 40 kHz, since at lower frequencies the first subharmonics f/2 go into the audible range. In the upper direction, the limit is approximately 80 kHz, since at higher frequencies the absorption by the air is too great. At a sound frequency in the range from 40 kHz to 60 kHz, a path which can be overcome by the sound waves is sufficiently great even in a relatively large room of a building.

### BRIEF DESCRIPTION OF THE DRAWINGS

Exemplary embodiments of the invention are explained in more detail below on the basis of the drawing, in which:

FIG. 1 shows a comfort sensor for recording air-condition variables,

FIG. 2 shows a diagram of the operating mode of the comfort sensor, and

FIG. 3 shows a diagram of a variant of the comfort sensor.

FIG. 4a shows a comfort sensor in a room,

FIG. 4b shows the comfort sensor in a further room,

FIG. 5 shows a system for regulating and/or controlling air-conditioning variables.

### DETAILED DESCRIPTION

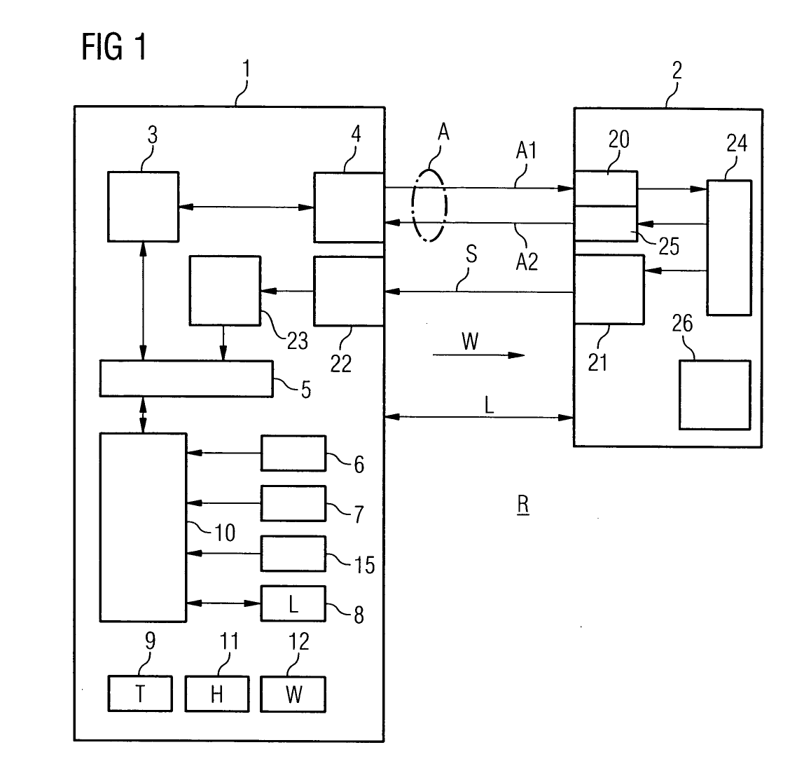

In FIG. 1, 1 designates a basic device and 2 an auxiliary device of a so-called comfort sensor, that is a device for recording air-conditioning variables. The basic device 1 and the auxiliary device 2 are arranged at a certain distance L away from each other in a room R of a building.

The basic device 1 has a sound transducer 4, which can be activated by means of a driver unit 3, and a timing unit 5. A humidity sensor 7 and, if need be, also a temperature sensor 6 are advantageously arranged in the basic device 1. The basic device 1 also comprises a first memory location 8 for the distance L and a second memory location 9 for an average temperature T, determined by the device for the room R of a building. The basic device 1 advantageously has at least one processor 10.

The temperature sensor 6 is advantageously a low-cost configuration, for example a nickel sensor, which is advantageously used in an iteration process for the calculation of an average temperature T only for generating a starting value or estimated value.

A third memory location 11, for an air humidity H of the room R of a building, recorded with the aid of the humidity sensor 7, and a fourth memory location 12, for a determined air movement W in the room R of a building, are advantageously arranged in the basic device 1.

If need be, the comfort sensor also has a gas sensor 15 for recording a specific constituent from the air of the room R in a building. The gas sensor 15 is, for example, a CO₂ sensor.

The auxiliary device 2 has a sound receiver 20. To set up a signaling channel S between the auxiliary device 2 and the basic device 1, a transmitter 21 is arranged in the auxiliary device 2 and a receiver 22 is arranged in the basic device 1. In the basic device 1, the receiver 22 is connected to the timing unit 5 via a driver 23.

A timing element 24 is arranged in the auxiliary device 2 and is connected on the input side to the sound receiver 20. The timing element 24 arranged in the auxiliary device 2 has an output connected to the transmitter 21.

In an advantageous variant of the auxiliary device 2, there is a sound transmitter 25, which can be activated via a further output of the timing element 24 arranged in the auxiliary device 2. The sound receiver 20 and the sound transmitter 25 are implemented for example in a single component.

The auxiliary device 2 advantageously has a subassembly 26 for supplying the auxiliary device 2 with energy independently of the power supply system. The subassembly 26 is, for example, a battery or some other known energy converter.

Sound waves A1 generated by the sound transducer 4 pass through the room R of a building over the distance L and impinge on the sound receiver 20 arranged in the auxiliary device 2.

Sound waves A2 impinging on the sound transducer 4 pass through the room R of a building in the opposite direction to the sound waves A1 emanating from the basic unit 1. The sound waves A2 are sound waves generated by the sound transmitter 25 or sound waves A1 generated by the sound transducer 4 and reflected by an obstacle. In an ideal case, the obstacle at least partly reflecting the sound waves A1 is the auxiliary device 2 or else an object—for example a wall or pillar—on which the auxiliary device 2 is arranged. In the sound transducer 4, the impinging sound waves A2 are converted into electric signals.

The driver unit 3 serves for operating the sound transducer 4 and on the one hand supplies electric signals for activating the sound transducer 4. On the other hand, the electric signals generated by the sound transducer 4 are adapted by the driver unit 3 to the requirements of the timing unit 5 and passed on to the latter.

The timing unit 5 is used to coordinate the timing of the activation of the sound transducer 4 and the evaluation of the electric signals generated by the sound transducer 4 and the electric signals transmitted by the driver 23 and to arrange that a transit time which the sound waves require for traveling the distance L can be determined.

If need be, the timing device 5 comprises an additional processor or microcomputer, or the timing unit 5 and the processor 10 may be realized as a single large-scale integrated unit.

An acoustic path A formed by the sound waves A1 and A2 is advantageously aligned in the room R in such a way that, as far as possible, the sound waves propagate mainly with an air draft that is to be expected in the room R or against the air draft.

In an optimum case, the air movement W is identical to the component of the air draft recorded with the aid of the acoustic path A.

For a more specific description of the operating mode of the device represented in FIG. 1, the following symbols are used, some of which have already been introduced above:
L distance between the basic device 1 and the auxiliary device 2
W component of the air movement recorded on the acoustic path
c₀ speed of sound in air
t_{f} transit time of the sound waves A1 from the basic device 1 to the auxiliary device 2, and
t_{b} transit time of the sound waves A2 from the auxiliary device 2 back to the basic device 1.

With the above symbols, the following equations are obtained for an outward path in the direction of the air movement W and a return path counter to the air movement W:
c₀+W=(L/t_{f}) [equation 1]
c₀+W=(L/t_{b}) [equation 2]

By subtraction of equation 2 from equation 1:
W=(L/2) (1/t_{f}−1/t_{b}) [equation 3]

With the aid of the two measured transit times t_{f} and t_{b} of the sound waves A1 and A2 traveling in opposite directions over the distance L, the air movement W can therefore be calculated independently of the speed of sound with equation 3.

An advantageous method for recording an air movement W by means of sound waves comprises the following four method phases:

A first method phase, in which the path L between the basic device 1 and the auxiliary device 2 is determined and stored in the first memory location 8. A second method phase, in which the transit time t_{f} which the sound waves A1 require on the path L from the basic device 1 to the auxiliary device 2 is determined. A third method phase, in which the transit time t_{b} which the sound waves A2 require on the path L from the auxiliary device 2 to the basic device 1 is determined. A fourth method phase, in which the air movement W is calculated in accordance with the equation 3 and stored in the fourth memory location 12.

The first method phase is advantageously carried out each time the device is newly started and repeated as and when required. The first method phase is therefore repeated for example whenever an unexpectedly great sudden change in the values of the air movement or the room temperature determined with the aid of the sound waves is established. A sequence with the second, third and fourth method phases is advantageously repeated periodically in such a way that available values for the air movement W are sufficiently up to date.

In the first method phase, the distance L is advantageously determined with the aid of the sound waves of the acoustic path A, an iteration process proposed in EP-A-1 203 936 being used. The known iteration process for determining the distance L makes it possible for example to avoid manually measuring the distance L and reading the measured distance L into the basic device 1.

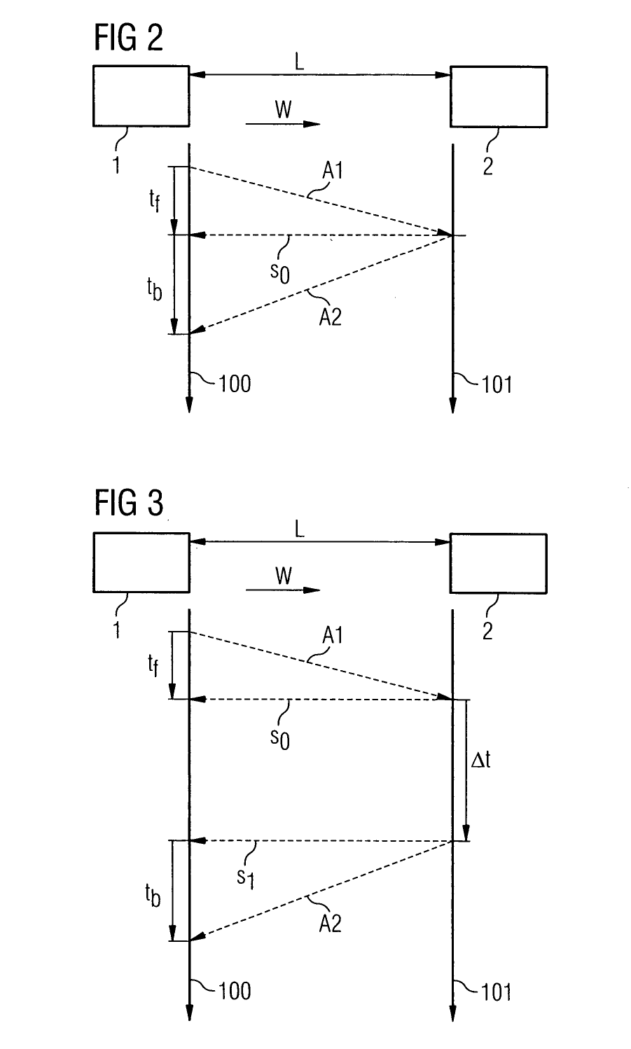

To describe the time sequence of the second and third method phases, in FIG. 2 events in the basic device 1 are plotted on a first time axis 100, while events in the auxiliary device 2 are represented on a second time axis 101.

In the second method phase, the sound transducer 4 emits the sound waves A1, which arrive at the sound receiver 20 (FIG. 1) of the auxiliary device 2 after the transit time t_{f}. The event of the arrival of the sound waves A1 at the sound receiver 20 is detected in the auxiliary device 2 by the timing element 24, which directly triggers a stop signal S₀ conducted over the signaling channel S. The stop signal S₀ passed on in the basic device 1 to the timing unit 5 makes it possible to record the transit time t_{f} by the timing unit 5.

The transmission speed of the stop signal S₀ over the signaling channel S must therefore be at least so great that a transit time of the stop signal S₀ is negligible in comparison with the transit time t_{f} of the sound waves A1. The signaling channel S advantageously operates wirelessly, thereby dispensing with wire connections between the basic device 1 and the auxiliary device 2. The two stated requirements are satisfied for example if the signaling channel S is implemented by an optoelectronic connection. For example, the transmitter 21 has a light-emitting diode and the receiver 22 has a matching phototransistor.

The third method phase can be implemented in principle in three different variants. In a first variant, no sound transmitter 25 is required in the auxiliary device 2, since the transit time t_{b} is determined by means of sound waves originally generated in the basic device 1 and reflected by an obstacle. It is in this case assumed that the sound waves A2 detected at the basic device 1 are reflected in a plane of the auxiliary device 2, that is at the distance L, and returned to the basic device 1. The stop signal S₀ transmitted in the second method phase over the signaling channel S to the basic device 1 (FIG. 2) is at the same time a start signal for the sound waves A2 emitted at the auxiliary device 2 by reflection to the basic device 1, which arrive at the sound transducer 4 of the basic device 1 after their transit time t_{b}, which can be recorded by the timing unit 5.

In a second variant of the third method phase, the auxiliary device 2 has the sound transmitter 25, from which the sound waves A2 are transmitted to the basic device 1 at the same time as the stop and start signal S₀, arriving at the sound transducer 4 of the basic device 1 after their transit time t_{b}, which can be recorded by the timing unit 5. The sound waves A2 are advantageously triggered by the timing element 24 at the same time as the stop and start signal S₀.

Also in a third variant of the third method phase, the auxiliary device 2 requires the sound transmitter 25. After the stop signal S₀ has been transmitted in the second method phase over the signaling channel S to the basic device 1 (FIG. 3), an actual start signal S₁ and at the same time the sound waves A2 are triggered by the timing element 24 only after a certain delay time Δt. The sound waves A2 arrive at the sound transducer 4 of the basic device 1 after their transit time t_{b}, which can be recorded by the timing unit 5. The delay time Δt is advantageously chosen to be at least so great that expected reflections of the sound waves A1 emitted by the sound transducer 4 are certain to have died away.

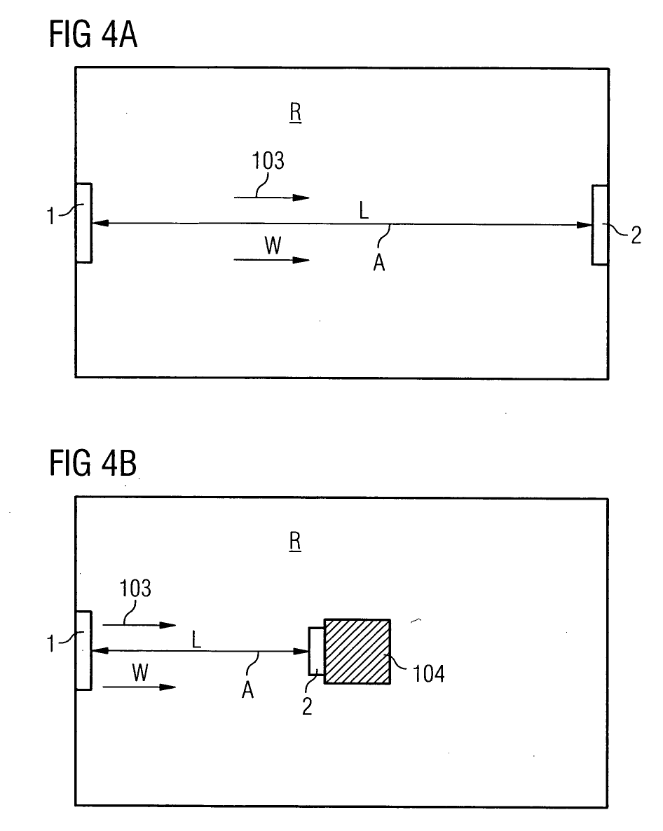

For the room R of a building represented in FIG. 4a, an arrow 103 indicates the main direction of a draft to be expected. The acoustic path A is advantageously arranged in the draft that is to be expected, in that the basic device 1 and the auxiliary device 2 are correspondingly arranged for example on opposite walls of the room R of a building.

In an advantageous arrangement, represented in FIG. 4b, the room R of a building has a body, for example a pillar 104, on which the auxiliary device 2 is arranged in such a way that the acoustic path A lies in the draft to be expected.

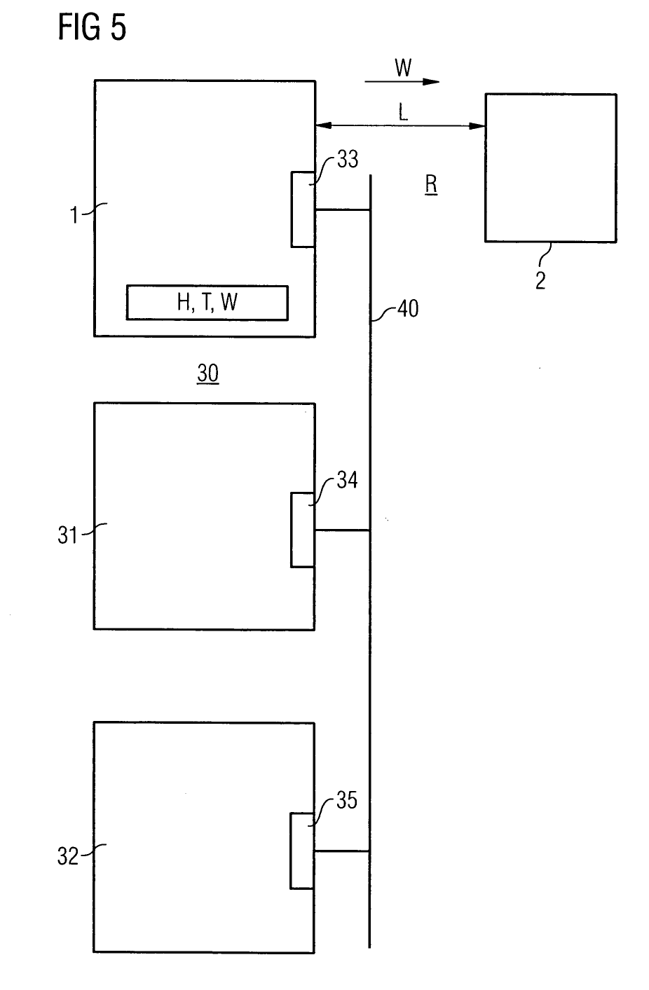

In FIG. 5, 30 signifies a system for regulating and/or controlling air-conditioning variables of the room R. The system 30 has at least one regulating device 31, an actuating element 32 and a comfort sensor comprising the basic device 1 and the auxiliary device 2. In the comfort sensor, at least the relative humidity H, the tempterature T and the air movement W of the room R in the building are stored. The regulating device 31, the actuating element 32 and the device 1 each have an interface unit 33, 34 and 35, respectively, which is connected to a communication medium 40. Process variables—for example air-conditioning values or actuating signals—can be exchanged via the communication medium 40 between the participating stations, namely the comfort sensor, the regulating device 31 and the actuating device 32. The communication medium 40 is a wired or a wireless connecting device. In FIG. 5, typically part of a building services control system is represented.

It goes without saying that, if need be, the regulating device 31 and the basic device 1 of the comfort sensor can also be realized in a single subassembly.

1-10. (canceled)

11. A device for recording air conditioning variables in a room of a building comprising:
a sound transducer for generating and receiving sound waves,
a processor unit for time-controlling and processing signals for recording the transit times of the sound waves for a certain distance,
a recording arrangement configured to record the room temperature,
a humidity sensor,
an auxiliary device, arranged in the room of a building at a certain distance form the sound transducer, comprising a soundwave receiver and a transmitter for a triggering signal,
a signaling channel, which can be set up between the transmitter and a receiver for transmitting the triggering signal from the auxiliary device to the processor unit, wherein,
the soundwave receiver is connected to the transmitter of the triggering signal in such a way that when a sound signal is received, the triggering signal can be transmitted over the signaling channel to the processor unit.

12. The device as claimed in claim 11, wherein the auxiliary device has a soundwave transmitter for generating sound waves.

13. The device as claimed in claim 12, wherein the soundwave transmitter is connected to the transmitter of the triggering signal such that when a sound signal is transmitted, the triggering signal can be transmitted over the signaling channel to the processor unit.

14. The device as claimed in claim 11, further comprising an additional sensor element for recording a gas in the room of a building.

15. The device as claimed in claim 14, wherein the carbon dioxide content can be recorded by the additional sensor element.

16. A method for recording air-conditioning variable, comprising the steps of:
emitting sound waves (A1) over a certain path from a basic device to an auxiliary device,
detecting the sound waves (A1) in the auxiliary device,
sending a signal from the auxiliary device to the basic device or a signaling channel when the sound waves (A1) are detected,
receiving the signal in the basic device and measuring a transit time (t_{f}) of the sound waves from the basic device to the auxiliary device, and
detecting sound waves (A2) in the basic device.

17. The method as claimed in claim 16, further comprising the step of:
emitting sound waves (A2) and a start signal from the auxiliary device to the basic device.

18. The method as claimed in claim 16, further comprising the step of:
measuring a transit time (t_{b}) of the sound waves (A2) from the basic device to the auxiliary device.

19. The method as claimed in claim 18, further comprising the step of:
calculating an air movement in the room of a building using the two measured transit times (t_{f}, t_{b}) of the sound waves (A1, A2) and the path.

20. The method as claimed in claim 17, further comprising the step of:
measuring a transit time (t_{b}) of the sound waves (A2) from the basic device to the auxiliary device.

21. The method as claimed in claim 20, further comprising the step of:
calculating an air movement in the room of a building using the two measured transit times (t_{f}, t_{b}) of the sound waves (A1, A2) and the path.

22. The method as claimed in claim 16, further comprising the step of:
measuring a transit time (t_{b}) of the sound waves (A2) from the auxiliary device to the basic device.

23. The method as claimed in claim 16, further comprising the step of:
calculating an average air temperature using the sound waves (A1, A2) exchanged between the basic device and the auxiliary device.

24. The method as claimed in claim 17, further comprising the step of:
calculating an average air temperature using the sound waves (A1, A2) exchanged between the basic device and the auxiliary device.

25. The method as claimed in claim 18, further comprising the step of:
calculating an average air temperature using the sound waves (A1, A2) exchanged between the basic device and the auxiliary device.

26. The method as claimed in claim 19, further comprising the step of:
calculating an average air temperature using the sound waves (A1, A2) exchanged between the basic device and the auxiliary device.

27. The method as claimed in claim 20, further comprising the step of:
calculating an average air temperature using the sound waves (A1, A2) exchanged between the basic device and the auxiliary device.

28. The method as claimed in claim 21, further comprising the step of:
calculating an average air temperature using the sound waves (A1, A2) exchanged between the basic device and the auxiliary device.

29. The method as claimed in claim 22, further comprising the step of:
calculating an average air temperature using the sound waves (A1, A2) exchanged between the basic device and the auxiliary device.
